(19) United States
(12) Patent Application Publication
(10) Pub. No.: US 2006/0101951 A1
(43) Pub. Date: May 18, 2006

(54) Method of and a tool for tightening threaded connectors

(76) Inventor: John K. Junkers, Saddle River, NJ (US)

Correspondence Address: STRIKER, STRIKER & STENBY, 103 EAST NECK ROAD, HUNTINGTON, NY, 11743, US

(21) Appl. No.: 10/987,922

(22) Filed: Nov. 12, 2004

(51) Int. Cl. B25B 21/00

(52) U.S. Cl. 81/57.14

(57) ABSTRACT

Tightening or loosening a threaded connector is performed by providing a tool with first and second tool parts, the second tool part being arranged coaxially around an outside circumference of the first tool part, engaging with a thread of a bolt a nut member provided with a plurality of screw members coaxial with the tool parts and screwable in the nut member and having gear-shaped portions jointly defining an inner gear ring and an outer gear ring, providing first connecting means for connecting the first tool part with the inner gear ring of the gear-shaped portions, providing second connecting means for connecting the second tool part with said outer gear ring of said gear shaped portions, with said first and second tool parts being arranged so as to provide equal and opposite turning forces, and operating the tool so that the first tool part applies a turning force in one direction to turn the gear-shaped portions of the screw members in a given turning direction while the second tool part applies a turning force in an opposite direction to the first tool part to also turn the gear-shaped portions of the screw members in the given turning direction, and thereby the screw members are tightened or loosened simultaneously.

### BACKGROUND OF THE INVENTION

The present invention relates to a method of and a tool for tightening threaded connectors.

More particularly it relates to a method of and a tool for tightening a threaded connector, with a nut engageable with a bolt and having a plurality of screw members of a gear-type shape, which screw members are turnable simultaneously to either tighten or loosen a fastener. The nut of the above mentioned general type and a device for tightening the same are disclosed in our U.S. Pat. No. 5,934,853.

The problem with the solution proposed in this patent is that when a socket with inner gears is connected with the gear-shaped portions of the screw members, a portion of the screw members can be pushed toward the bolt center when the tool is not absolutely held coaxial with the bolt. This means that some of the screw members either bend or are not turned, which would result in an unequal force applied by all screw members to stretch the bolt.

It is therefore believed to be advisable to eliminate the above described disadvantages of the device disclosed in this patent.

### SUMMARY OF THE INVENTION

Accordingly, it is an object of the present invention to provide a method of and a tool for tightening threaded connectors, which eliminates the disadvantages of the prior art.

In keeping with these objects and with others will become apparent hereinafter, one feature of the present invention resides, briefly stated, in a method of tightening or loosening a threaded connector, comprising the steps of providing a tool with first and second tool parts, said second tool part being arranged coaxially around an outside circumference of said first tool part; engaging with a thread of a bolt a nut member provided with a plurality of screw members coaxial with said tool parts and screwable in said nut member and having gear-shaped portions jointly defining an inner gear ring and an outer gear ring; providing first connecting means for connecting said first tool part with said inner gear ring of said gear-shaped portions; providing second connecting means for connecting said second tool part with said outer gear ring of said gear-shaped portions, with said first and second tool parts being arranged so as to provide equal and opposite turning forces; and operating the tool so that said first tool part applies a turning force in one direction to turn said gear-shaped portions of said screw members in a given turning direction while said second tool part applies a turning force in an opposite direction to said first tool part to also turn said gear shaped portions of said screw members in said given turning direction, and thereby said screw members are tightened or loosened simultaneously.

Another feature of the present invention resides, briefly stated, in a tool for tightening or loosening a threaded connector, comprising coaxial first and second tool parts; a nut member engageable with a thread of a bolt and provided with a plurality of screw members coaxial with said tool parts and screwable in said nut member and having gear-shaped portions jointly defining an inner gear ring and an outer gear ring; first connecting means for connecting said first tool part with said inner gear ring of said gear-shaped portions, and second connecting means for connecting said second tool part arranged around an outside circumference of said first tool part with said outer ring of said gear-shaped portions, said first and said second tool parts being arranged so as to provide equal and opposite turning forces, so that when the tool is operated and said first tool part applies a turning force in one direction to turn said gear-shaped portions of said screw members in a given turning direction while said second tool part applies a turning force in an opposite direction to said first tool part to also turn said gear-shaped portions of said screw members in said given turning direction, said screw members are tightened or loosened simultaneously.

Another feature of the present invention resides, briefly stated in having the gear-shaped portions of equal length screw members aligned to be on the same plane relatively to each other and parallel relative to the face of said nut member so that when the first and second tools parts are engaged with said inner and outer gear ring respectively and turned, said screw members apply a circumferential and equal pushing force onto the surface of the parts to be assembled by said threaded connector.

When the method is performed and the tool is designed in accordance with the present invention, the inner gear member connected with the gear-shaped portions of the screw members turns in one direction, the screw members turn in a given turning direction, and when the outer gear member connected with the gear-shaped portions of the screw members turns in the other opposite direction, the screw members turn in the same given turning direction, and the screw members turn in the same direction.

In the tool an action force can be applied for example to turn the inner ring member for example in a clockwise direction, and an equal an opposite reaction force is applied to turn the outer ring member in another opposite direction, and as a result the screw members engaged by the inner and outer ring members are turned in the same direction. The tool applies its forces coaxially without applying a bending force to the screw members. Also, the tool does not have to divert its reaction force to an outside stationary object, as was the case in known tools.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a sectional elevation view of a tool in accordance with the present invention which illustrates an inventive method; and

FIG. 2 is a view showing a section taken along the line II-II in FIG. 1.

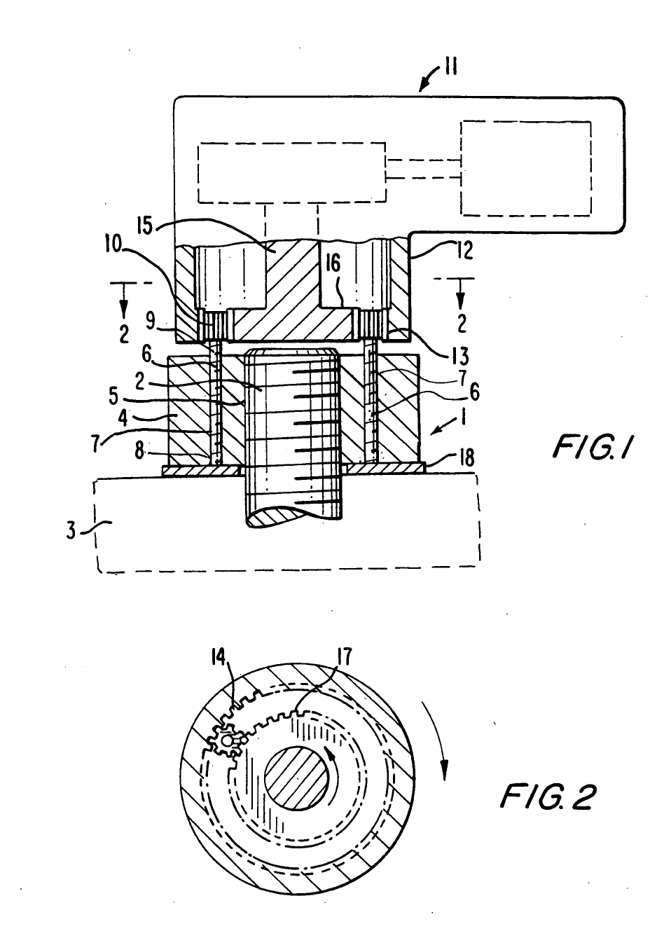

### DESCRIPTION OF THE PREFERRED EMBODIMENTS

A method of tightening and a device for tightening threaded fasteners in accordance with the present invention is used with a fastener which includes a nut identified as a whole with reference numeral 1 and a bolt and the like identified with reference 2. The nut 1 is screwed on the bolt 2, and the bolt 2 is screwed into an object which is identified with reference numeral 3.

The nut 1 has a substantially cylindrical nut member 4 provided with an inner thread 5 for engaging with the bolt 2. The nut 1 further has a plurality of screw members 6 which are screwed in a plurality of threaded holes 7. The threaded holes 7 are arranged coaxially around the inner thread 5 of the nut member 4 and can be spaced from one another by substantially equal peripheral distances.

Each screw member 6 has a first end 8 adapted to abut against the object 3, and a second opposite end 9 provided with a gear-shaped member or a gear 10. The gear 10 is non-rotatably mounted on the end 9 of each screw member 6 for joint rotation with the screw member.

A tool for tightening the threaded connector is identified as a whole with reference numeral 11. The tool 11 can be formed as a power tool. It has a first element identified with reference numeral 12 and provided with a first connecting means 13. The first tool element 12 is formed as a female member with the connecting means 13 formed for example as an inner gear or in other words as a gear provided with inner teeth 14. The tool further has a second tool element which is identified with reference numeral 15 and has second connecting means 16. The tool element 15 is formed as a male member and in particular as a gear in which the connecting means 16 are formed by outer teeth 17. The teeth 14 and 17 are formed so that they are engageable with the teeth of the gears 10 of the screw members 6 from outside and from inside correspondingly.

The tool element 15 can be connected with an active part of the tool 11, for example with a ratchet of a pawl-ratchet mechanism driveable by a fluid-operated cylinder-piston unit, as disclosed for example in our U.S. Pat. No. 6,112,622. The tool element 12 can be connected for example with a housing of the same tool 11.

Finally, reference numeral 18 in the drawings identifies a conventional washer which can be applied between the nut 1 and the object 2, as well known in the art.

In accordance with the present invention the inventive method of tightening is implemented and the inventive tool operates in the following manner:

When it is necessary to tighten the nut 1 on the bolt 2, the tool 11 is activated, and the tool elements 12 and 15 are turned in opposite directions. For example, an action force is applied by the tool part 15 which is rotated, for example by the ratchet driveable by the drive, while an equal and opposite reaction force is applied by the tool part 12 which is immovably connected with the housing turnable in an opposite direction due to the thusly generated reaction. The tool element 15 engages the gears 10 of the screw members 6 from inside and turns them in a given turning direction, while the tool element 12 engages the gears 10 of the screw members 6 from outside and turns them in the same direction. All screw members 6 are turned simultaneously, their lower ends 8 abut against the washer 18, and during turning of the screw members 6 the nut 1 is displaced in an axial direction to be tightened on the bolt 2.

The loosening of the nut 1 from the bolt 2 is performed by turning the tool elements 12 and 15 in opposite directions.

It will be understood that each of the elements described above, or two or more together, may also find a useful application in other types of constructions differing from the types described above.

While the invention has been illustrated and described as embodied in a method of and a tool for tightening threaded connectors, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method of tightening or loosening a threaded connector, comprising the steps of providing a tool with first and second tool parts, said second tool part being arranged coaxially around an outside circumference of said first tool part; engaging with a thread of a bolt a nut member provided with a plurality of screw members coaxial with said tool parts and screwable in said nut member and having gear-shaped portions jointly defining an inner gear ring and an outer gear ring; providing first connecting means for connecting said first tool part with said inner gear ring of said gear-shaped portions; providing second connecting means for connecting said second tool part with said outer gear ring of said gear-shaped portions, with said first and second tool parts being arranged so as to provide equal and opposite turning forces; and operating the tool so that said first tool part applies a turning force in one direction to turn said gear-shaped portions of said screw members in a given turning direction while said second tool part applies a turning force in an opposite direction to said first tool part to also turn said gear-shaped portions of said screw members in said given turning direction, and thereby said screw members are tightened or loosened simultaneously.

2. A method as defined in claim 1; and further comprising forming said first part as a male part, and providing first connecting means on an outer periphery of said male part.

3. A method as defined in claim 1; and further comprising forming said second part as a female part; and providing said second connecting means on an interior of said female part.

4. A method as defined in claim 2; and further comprising forming said first part gear-shaped as an outer gear.

5. A method as defined in claim 1; and further comprising forming said second tool part gear-shaped as an inner gear.

6. A method as defined in claim 1; and further comprising arranging said first connecting means and said second connecting means coaxial with one another and turnable about a common axis.

7. A tool for tightening or loosening a threaded connector, comprising coaxial first and second tool parts; a nut member engageable with a thread of a bolt and provided with a plurality of screw members coaxial with said tool parts and screwable in said nut member and having gear-shaped portions jointly defining an inner gear ring and an outer gear ring; first connecting means for connecting said first tool part with said inner gear ring of said gear-shaped portions, and second connecting means for connecting said second tool part arranged around an outside circumference of said first tool part with said outer ring of said gear-shaped portions, said first and said second tool parts being arranged so as to provide equal and opposite turning forces, so that when the tool is operated and said first tool part applies a turning force in one direction to turn said gear-shaped portions of said screw members in a given turning direction while said second tool part applies a turning force in an opposite direction to said first tool part to also turn said gear-shaped portions of said screw members in said given turning direction, said screw members are tightened or loosened simultaneously.

8. A tool as defined in claim 7, wherein said first tool part is formed as a male part, and said first connecting means are provided on an outer periphery of said male part.

9. A tool as defined in claim 7, wherein said second tool part is formed as a female part, and said second connecting means are provided on an interior of said female part.

10. A tool as defined in claim 8, wherein said first tool part with said first connecting means is gear-shaped and formed as an outer gear.

11. A method as defined in claim 9, wherein said second tool part with said second connecting means is gear-shaped and formed as an inner gear.

12. A method as defined in claim 7, wherein said first connecting means and said second connecting means are coaxial with one another and turnable about a common axis.
